(19) United States
(12) Patent Application Publication
(10) Pub. No.: US 2009/0251407 A1
(43) Pub. Date: Oct. 8, 2009

(54) DEVICE INTERACTION WITH COMBINATION OF RINGS

(75) Inventors: Gary W. Flake, Bellevue, WA (US); Blaise Aguera y Arcas, Seattle, WA (US); Brett D. Brewer, Sammamish, WA (US); Steven Drucker, Bellevue, WA (US); Karim Farouki, Seattle, WA (US); Ariel J. Lazier, Seattle, WA (US); Stephen L. Lawler, Redmond, WA (US); Donald James Lindsay, Mountain View, CA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/062,302

(22) Filed: Apr. 3, 2008

(51) Int. Cl. G06F 3/033

(52) U.S. Cl. 345/156

(57) ABSTRACT

The claimed subject matter provides a system and/or a method that facilitates interacting with a device and/or data associated with the device. A computing device can display a portion of data. A ring component can interact with the portion of data to control the device by detecting at least one of a movement, a gesture, an inductance, or a resistance related to a user wearing the ring component on at least one digit on at least one hand.

### BACKGROUND

Technological advances in computer hardware, software and networking have lead to increased demand for electronic information exchange rather than through conventional techniques such as paper and telephone correspondence, for example. Such electronic communication can provide split-second, reliable data transfer between essentially any two locations throughout the world. Many industries and consumers are leveraging such technology to improve efficiency and decrease cost through web-based (e.g., on-line) services. For example, consumers can purchase goods or services, review bank statements, research products and companies, obtain real-time stock quotes, download pictures, download video, communicate in real-time, etc. with the click of a mouse and at the convenience of home.

As the amount of available electronic data grows, it becomes more important to interact and/or utilize such data in a manageable and user-friendly manner. As a result, computing devices have incorporated a variety of techniques and/or methods for inputting information. Computing devices facilitate entering information employing devices such as, but not limited to, keyboards, keypads, touch pads, touch-screens, speakers, stylus' (e.g., wands), writing pads, voice recognition hardware, and the like. Yet, such conventional data input techniques have not adapted to keep pace with the technological advances in the devices for which they are used. In addition, a typically input device such as a mouse, a pointing device, a stylus, a touch pad, and the like can be difficult to use while in motion (e.g., walking, running, driving, flying, etc.). Although wireless headsets have mitigated the difficulties in regards to interacting with devices and/or device data, such devices tend to be uncomfortable, non-private (e.g., communications and interactions can be overheard), and an eye-sore for most.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to systems and/or methods that facilitates controlling and interacting with computing devices in a more convenient and efficient manner. A ring component can be worn on a digit or a toe on a user, wherein such ring component can be utilized to communicate with a device using one or more rings as inputs. For instance, the ring component can detect conductance, inductance, resistance, and other properties related to one or more digits (e.g., fingers) or toes. The ring component can further identify motions, gestures, or interactions for wireless data input or wireless interaction in connection with the device, a display (e.g., user interface) on the device, or displayed data. In one example, the ring component can detect a twisting motion from a user's hand, which can correspond to moving a scroll bar displayed by a user interface (UI) on the device.

Furthermore, the ring component can incorporate various sensors in order to collect data in real-time associated with the user. In general, the ring component can enable data collection and communication such as receiving inputs from a user and communicating outputs to a user. Additionally, the ring component can provide proximity alerts in connection with a friend or contact being within a determined geographic proximity of the user wearing the ring component. In another instance, the rings can be extended to other parts of the body (e.g., waist, neck, legs, etc.) to enable full-body data collection. Moreover, the device or display on the device can integrate physical feedback in connection with the rings to optimize usability. In other aspects of the claimed subject matter, methods are provided that facilitate incorporating one or more sensors into a ring component worn by a user to collect information for device interaction.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 illustrates a block diagram of an exemplary system that facilitates communicating with a device utilizing a ring component worn by a user on a digit.

FIG. 2 illustrates a block diagram of an exemplary system that facilitates incorporating one or more sensors into a ring component worn by a user to collect information for device interaction.

FIG. 3 illustrates a block diagram of an exemplary system that facilitates employing one or more ring components to communicate or interface with a device displaying a portion of data.

FIG. 4 illustrates a block diagram of an exemplary system that facilitates utilizing a ring component worn by a user on a digit to output information or data to such user.

FIG. 5 illustrates a block diagram of exemplary system that facilitates communicating with a portion of data on a device in accordance with an aspect of the subject innovation.

FIG. 6 illustrates a block diagram of an exemplary system that facilitates inferring and/or predicting a user's intended interaction with a device with a ring component.

FIG. 7 illustrates an exemplary methodology for communicating with a device utilizing a ring component worn by a user on a digit.

FIG. 8 illustrates an exemplary methodology that facilitates employing one or more ring components to communicate or interface with a device displaying a portion of data.

FIG. 9 illustrates an exemplary networking environment, wherein the novel aspects of the claimed subject matter can be employed.

FIG. 10 illustrates an exemplary operating environment that can be employed in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “device,” “sensor,” “store,” “engine,” “aggregator,” and the like are intended to refer to a computer-related entity, either hardware, software (e.g., in execution), and/or firmware. For example, a component can be a process running on a processor, a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

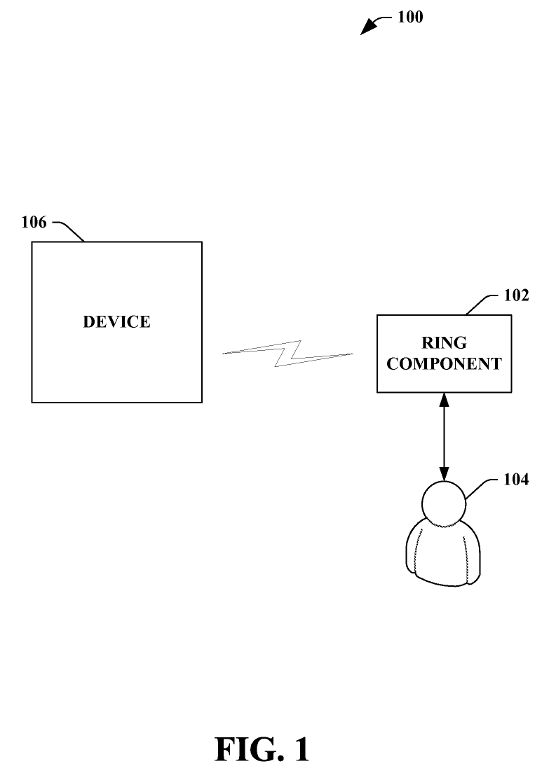

Now turning to the figures, FIG. 1 illustrates a system 100 that facilitates communicating with a device utilizing a ring component worn by a user on a digit. The system 100 can include a ring component 102 that enables a user 104 to interact and/or communicate with a device 106 based upon detected data associated with such user 104. In particular, the ring component 102 can be worn by the user 104 on, for instance, at least one finger on a hand or at least one toe on a foot. By wearing the ring component 102 on a digit or finger on a hand or a toe on a foot, data collection and interaction with the device 106 can be more manageable and efficient. For example, the ring component 102 can be a decorative piece worn by the user 104 as well as an input device for the device 106. In other words, data collection from the user 104 can be seamlessly implemented by the ring component 102 in connection with the device 106.

The ring component 102 can aggregate data from the user 102 such as, but not limited to, conductance, inductance, resistance, motions, gestures, and the like. For example, a specific motion can be detected by the ring component 102 in which such specific motion can initiate a particular control, feature, or function of the device 106. In another example, the ring component 102 can be activated by identifying a level of conductance related to a specific user. Thus, a conductance level can be a security measure which prevents other users from interacting with the device 106 with the ring component 102. In other words, real-time data collected by the ring component 102 from the user 104 can be utilized to interact with the device 106 and/or data displayed or associated with the device 106. Moreover, the user 104 can be employed as an input and/or an output in connection with the device 106.

In an example, the user 104 can link a detectable input received by the ring component 102 to a function or feature on the device 106, wherein the device is a mobile communication device. Such detectable input can be a particular motion received by the ring component 102 being worn on a finger or toe of the user 104. For instance, the simulated motion of twisting a knob can be detected by the ring component 102 and can interact with the device 106 by providing a scrolling, volume adjustment, data browsing, zooming, any suitable data interaction or control, etc. In another example, the ring component 102 can detect a shaking motion by the user 104 in which such shaking motion can initiate a speed dial for a particular contact. It is to be appreciated that the above examples are not to be limiting on the subject innovation and any suitable detected activity from the ring component 102 can be employed to interact with the device 106.

In addition, the system 100 can include any suitable and/or necessary interface component (not shown), which provides various adapters, connectors, channels, communication paths, etc. to integrate the ring component 102 into virtually any operating and/or database system(s) and/or with one another. In addition, the interface component can provide various adapters, connectors, channels, communication paths, etc., that provide for interaction with the ring component 102, the user 104, the device 106, and any other device and/or component associated with the system 100.

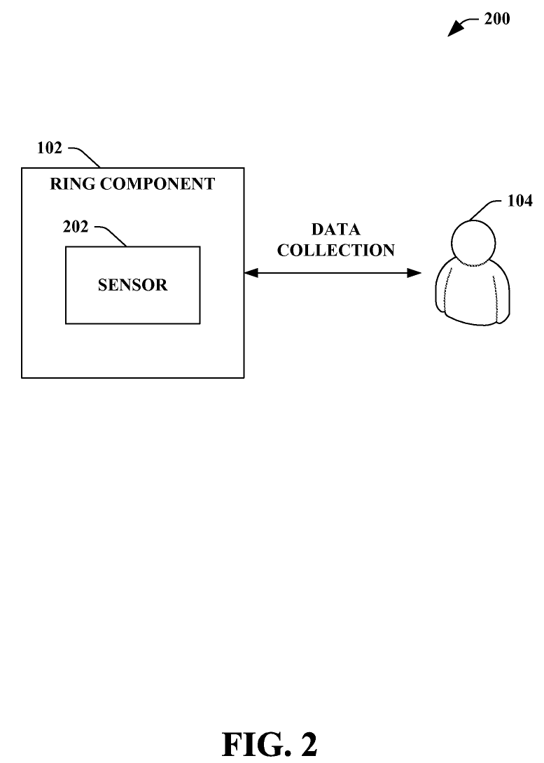

FIG. 2 illustrates a system 200 that facilitates incorporating one or more sensors into a ring component worn by a user to collect information for device interaction. The system 200 can include the ring component 102 which allows real-time data collection in connection with the user 104. Specifically, the ring component 102 can be worn by the user 102 on a digit or finger on at least one hand or on a toe on at least one foot. It is to be appreciated that the ring component 102 can be further attached to or worn on a portion of the user (e.g., a ring on a necklace, etc.), a waist of a user, a leg of a user, an arm of a user, a wrist of a user, a neck of a user, an ankle of a user, and/or any other body part of portion of the user to which a ring can worn.

The ring component 102 can provide inputs to the device 106 as well as outputs to the user from the device 106. The device 106 can be, but is not limited to being, a computing device, a smartphone, a mobile communication device, a machine, a computer, a laptop, a portable digital assistant (PDA), a data browsing device, a display (e.g., a television, a plasma display, an LCD, a flat screen, a computer display, a CRT, a monitor, etc.), a gaming device, a portable device, a portable gaming device, a two-way communication device, a hand-held, a global positioning system (GPS) device, a media player, a media device (e.g., audio player, video player, etc.), a cellular device, a wireless device, etc.

The ring component 102 can further include a sensor 202 that can collect data from the user 104 in real-time. It is to be appreciated that the sensor 202 can be incorporating into the ring component 102, attached to the ring component 102, a stand-alone component that can communicate with the ring component 102, and/or any other suitable combination thereof. For example, the sensor 202 can be, but is not limited to being, an accelerometer, a global positioning system (GPS) sensor, a biometric sensor (e.g., heart rate, blood pressure, breathing patterns, retinal activity, skin tone, neural activity, etc.), temperature sensor, pressure sensor, motion sensor, speed sensor, light sensor, sound sensor, moisture sensor, weight sensor, conductance sensor, resistance sensor, etc. In other words, the sensor 202 can be any suitable sensor that can collect data from a digit on a hand or a toe on a foot associated with the user 104. Moreover, the sensor 202 can collect data from the user 104 which can be utilized to indicate a mood or emotion. For example, the sensor 202 can gather the biometric measurements related to temperature, perspiration, heart rate, breathing pattern, skin tone (e.g., more red indicates increased blood pressure, etc.), and the like to identify whether the user 104 is happy, sad, nervous, angry, agitated, annoyed, stressed, excited, etc. Based on such emotion, the device 106 can change functionality, features, modes, and/or displayed data. In still another example, the ring component 102 can be a sensor itself to provide at least one of radio frequency identification (RFID) functionality, proximity detection, Wi-Fi capabilities, context awareness, etc.

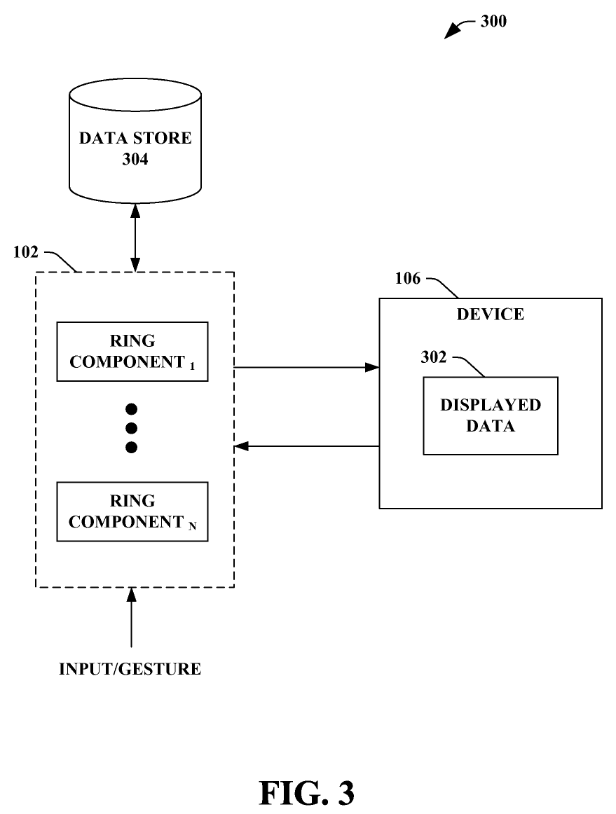

FIG. 3 illustrates a system 300 that facilitates employing one or more ring components to communicate or interface with a device displaying a portion of data. The system 300 can include at least one ring component 102 that can be worn by a user in order to conveniently collect data that can be utilized for interaction or control of the device 106. At least one ring component 102 can receive an input and/or a gesture that can be implemented to control or communicate with the device 106. It is to be appreciated that there can be any suitable number of ring components 102 such as ring component 1 to ring component N, where N is a positive integer.

For instance, a user can wear a first ring component and a second ring component, wherein the ring components can detect parameters in connection with one another. In other words, orientation, distance, location, contact, proximity, motion, etc. between two or more ring components can be utilized as an input for the device 106. In one example, the first ring component can be on a digit on a first hand and the second ring component can be on a digit on a second hand, in which the orientation and interaction between the two rings can control and/or communicate with the device 106. In still another example, a first motion used to make a first ring component contact a second ring component can be a first input for the device whereas a second motion to make the first ring component contact a second ring component can be a second input. In yet another example, the type of contact (e.g., location between rings, force, pressure, frequency, etc.) between the first ring component and the second ring component can be a particular input for the device. Moreover, it is to be appreciated that the two or more rings can be worn on at least two or more digits on at least one hand or two or more toes on at least one foot.

Furthermore, the ring component 102 can receive an input and/or gesture in order to interact with at least one of the device 106 or a portion of displayed data 302. In general, the ring component 102 can associate a detected input or gesture to a feature or a function with the device 106 or the displayed data 302. In other words, a user can perform a gesture or motion with a hand, finger, toe, or foot to control or interact with the device 106 or the displayed data 302. For example, the gesture can be, but is not limited to being, a squeeze, a pressure, a turning, a spinning, a speed in any suitable direction on a 3-dimensional axis, a linear movement, a movement or motion, an acceleration in a direction, a drawing of a character, a simulated portion of writing, a simulation of typing on a keyboard, a shaking motion, a stretching of fingers, a grabbing motion, a sign associated with sign language, a sign (e.g., an “OK” sign, a thumbs up, a thumbs down, a peace sign, stop signal, waive, etc.), a combination of displaying certain digits and not other digits, a gesture involving two hands (e.g., clapping, rubbing of hands together, etc.), a gesture involving a first finger on a first hand a second finger on a second hand (e.g., itsy-bitsy spider, a cross made with two index fingers, etc.), etc.

For instance, a shaking gesture can be linked to activate a speed dial for a particular individual with a mobile device. In another example, an “OK” sign can indicate to answer an incoming call. In another example, the stretching of fingers can clear a display of displayed data 302. Additionally, a disparate user can set the stretching of fingers motion to be for closing an application. It is to be appreciated that any suitable gesture detected by the ring component 102 can be linked to any suitable function or feature related to the device 106 or the displayed data 302, wherein such linkage can be a default setting (e.g., defined by the ring component 102, defined by the device 106, etc.), a user-defined setting, and/or any suitable combination thereof.

Moreover, the device 106 or display on the device can integrate physical feedback in connection with the ring component 102 to optimize usability. For instance, while scrolling through data on a device by a detected twisting motion from the ring component, the end of data and ability to scroll can be communicated to the user 104 by resistance in the twisting motion (e.g., making it harder for the user to perform the twisting motion). It is to be appreciated that any suitable output for physical feedback can be utilized and the above example is not to be limiting on the claimed subject matter.

The system 300 can further include a data store 304 that can include any suitable data related to the ring component 102, the device 106, a user (not shown), the displayed data 302, etc. For instance, the ring component 102 can include the data store 304 in order to provide portable storage worn on a digit on a hand for a user. For example, the data store 304 can include, but not limited to including, roaming identity, profiles, roaming profile, modes for inputs/outputs (e.g., meeting mode with non-disturbing alerts, outside mode with louder alerts, etc.), control definitions for the ring component 102 (e.g., motion linked to which controls on a device), user preference data, user defined controls, settings for the ring component 102, security information (e.g., username, passwords, log in, etc.), input settings for the ring component 102, output settings for the ring component 102, wireless settings, connectivity settings for the device to the ring component 102, sensor settings/configurations, user defined gestures, user defined linkage with device functionality, and/or any other suitable data related to the system 300 and/or features described in connection with the subject innovation.

It is to be appreciated that the data store 304 can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The data store 304 of the subject systems and methods is intended to comprise, without being limited to, these and any other suitable types of memory. In addition, it is to be appreciated that the data store 304 can be a server, a database, a hard drive, a pen drive, an external hard drive, a portable hard drive, and the like.

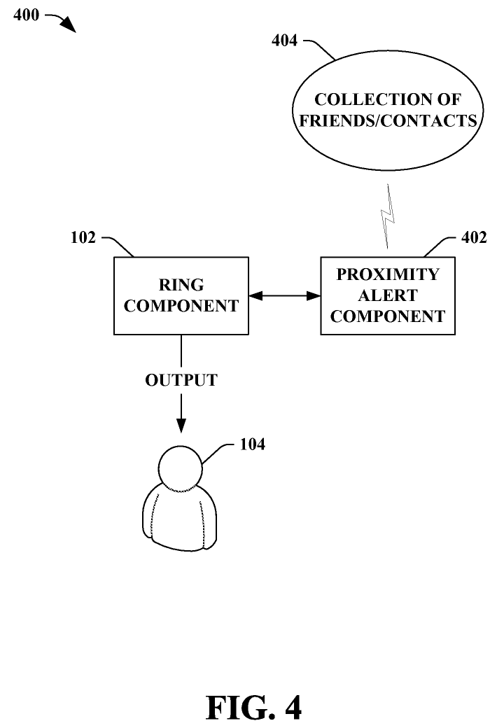

FIG. 4 illustrates a system 400 that facilitates utilizing a ring component worn by a user on a digit to output information or data to such user. The system 400 can include the ring component 102 that can provide at least one output the user 104, wherein the output can be related to a device (not shown) or a portion of displayed data. The ring component 102 can be worn by the user 104 on a finger or toe and movements, gestures, biometric information, conductance, resistance, and the like can be detected in real-time. The ring component 102 can further identify motions, gestures, and/or other interactions for wireless data input or wireless interaction in connection with the device, a display (e.g., user interface) on the device, or displayed data.

As discussed, the ring component 102 can be employed as an input to a device or for interaction of data on a device. Furthermore, the ring component 102 can be an output to communicate information to the user 104 from the device or data displayed on a device. In other words, a functionality or feature associated with a device can be linked to an output on the ring component 102 in order to communicate information. In general, an output related to a device can be mapped to an output available on the ring component 102 in order to transmit information to the user 104. The ring component 102 can provide an output such as, but not limited to, a vibration, a color change, a temperature change (e.g., an increase in ring temperature, a decrease in temperature, etc.), a sound, a portion of visual data, a scrolling marquee (e.g., text, graphics, etc.), a light, an attraction to a disparate ring, a repelling force to a disparate ring, and/or any other suitable output that can be incorporated into a ring worn on a digit on the user 104.

The ring component 102 can further leverage a proximity alert component 402 that can provide an alert to the user 104 (via the ring component 102) in the event that a friend or a contact from a collection of friends/contacts 404 is within a geographic proximity. The proximity alert component 402 can analyze geographic data related to the collection friends/contacts 404 and based on such analysis, an alert can be provided to the user 104 if a friend or contact is within a pre-determined geographic distance. It is to be appreciated that the friend or contact list can be created in accordance with the user's preferences. In addition, the user 104 can populate the friend/contact collection 404 with an address book, contact list, a data file, a social network, a network, and the like. Moreover, the geographic distance can be selected on a granular basis for each friend (e.g., a large distance for a close friend, a disparate distance for another friend, etc.). Still further, the type of output or alert to the user 104 can be specific for each friend or contact within a geographic proximity. Thus, a vibration output on the ring component 102 can be set as the alert for a first friend within a defined proximity, whereas a color change on the ring component 102 can be the alert for a second friend.

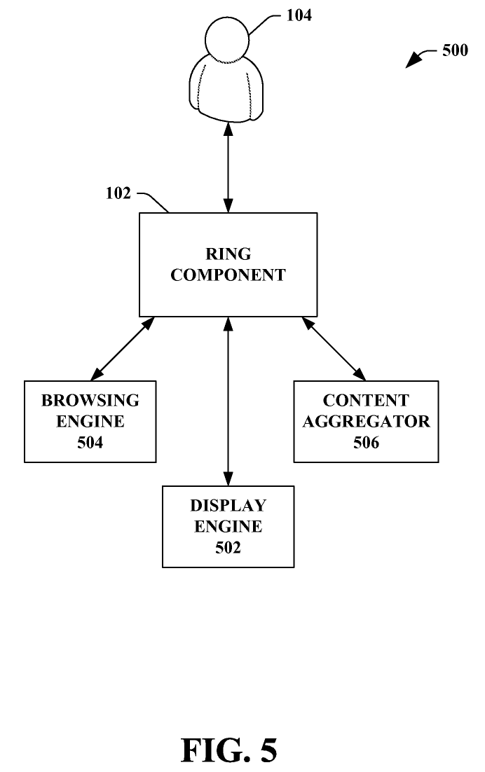

FIG. 5 illustrates a block diagram of exemplary system that facilitates interfacing with data associated with a display technique, a browse technique, and/or a virtual environment technique. The system 500 can include the ring component 102 that can be worn by the user 104 in order to provide seamless data interaction based on collected information from movements, inductance, resistance, etc. The system 500 can further include a display engine 502 that enables seamless pan and/or zoom interaction with any suitable displayed data, wherein such data can include multiple scales or views and one or more resolutions associated therewith. In other words, the display engine 502 can manipulate an initial default view for displayed data by enabling zooming (e.g., zoom in, zoom out, etc.) and/or panning (e.g., pan up, pan down, pan right, pan left, etc.) in which such zoomed or panned views can include various resolution qualities. The display engine 502 enables visual information to be smoothly browsed regardless of the amount of data involved or bandwidth of a network. Moreover, the display engine 502 can be employed with any suitable display or screen (e.g., portable device, cellular device, monitor, plasma television, etc.). The display engine 502 can further provide at least one of the following benefits or enhancements: 1) speed of navigation can be independent of size or number of objects (e.g., data); 2) performance can depend on a ratio of bandwidth to pixels on a screen or display; 3) transitions between views can be smooth; and 4) scaling is near perfect and rapid for screens of any resolution.

For example, an image can be viewed at a default view with a specific resolution. Yet, the display engine 502 can allow the image to be zoomed and/or panned at multiple views or scales (in comparison to the default view) with various resolutions. Thus, a user can zoom in on a portion of the image to get a magnified view at an equal or higher resolution. By enabling the image to be zoomed and/or panned, the image can include virtually limitless space or volume that can be viewed or explored at various scales, levels, or views with each including one or more resolutions. In other words, an image can be viewed at a more granular level while maintaining resolution with smooth transitions independent of pan, zoom, etc. Moreover, a first view may not expose portions of information or data on the image until zoomed or panned upon with the display engine 502.

A browsing engine 504 can also be included with the system 500. The browsing engine 504 can leverage the display engine 502 to implement seamless and smooth panning and/or zooming for any suitable data browsed in connection with at least one of the Internet, a network, a server, a website, a web page, and the like. It is to be appreciated that the browsing engine 504 can be a stand-alone component, incorporated into a browser, utilized with in combination with a browser (e.g., legacy browser via patch or firmware update, software, hardware, etc.), and/or any suitable combination thereof. For example, the browsing engine 504 can be incorporate Internet browsing capabilities such as seamless panning and/or zooming to an existing browser. For example, the browsing engine 504 can leverage the display engine 502 in order to provide enhanced browsing with seamless zoom and/or pan on a website, wherein various scales or views can be exposed by smooth zooming and/or panning.

The system 500 can further include a content aggregator 506 that can collect a plurality of two dimensional (2D) content (e.g., media data, images, video, photographs, metadata, trade cards, etc.) to create a three dimensional (3D) virtual environment that can be explored (e.g., displaying each image and perspective point). In order to provide a complete 3D environment to a user within the virtual environment, authentic views (e.g., pure views from images) are combined with synthetic views (e.g., interpolations between content such as a blend projected onto the 3D model). For instance, the content aggregator 506 can aggregate a large collection of photos of a place or an object, analyze such photos for similarities, and display such photos in a reconstructed 3D space, depicting how each photo relates to the next. It is to be appreciated that the collected content can be from various locations (e.g., the Internet, local data, remote data, server, network, wirelessly collected data, etc.). For instance, large collections of content (e.g., gigabytes, etc.) can be accessed quickly (e.g., seconds, etc.) in order to view a scene from virtually any angle or perspective. In another example, the content aggregator 506 can identify substantially similar content and zoom in to enlarge and focus on a small detail. The content aggregator 506 can provide at least one of the following: 1) walk or fly through a scene to see content from various angles; 2) seamlessly zoom in or out of content independent of resolution (e.g., megapixels, gigapixels, etc.); 3) locate where content was captured in relation to other content; 4) locate similar content to currently viewed content; and 5) communicate a collection or a particular view of content to an entity (e.g., user, machine, device, component, etc.).

The ring component 102 can be utilized as an input and/or an output in connection with at least one of the display engine 502, the browsing engine 504, and/or the content aggregator 506. For example, the ring component 102 can be worn on a finger or toe associated with the user 104 in which inputs and/or outputs collected therewith can enable interaction with the display engine 502 for seamless zooming, panning, etc. with displayed data having multiple scales or views. For example, a grabbing and pulling motion towards the user detected by the ring component 102 can indicate a zooming in on a portion of data using the display engine. In another example, the ring component 102 can enable exploration of data browsed with the browsing engine 504. Moreover, the content aggregator 506 can be controlled with the ring component 102 and the respective real-time data collected.

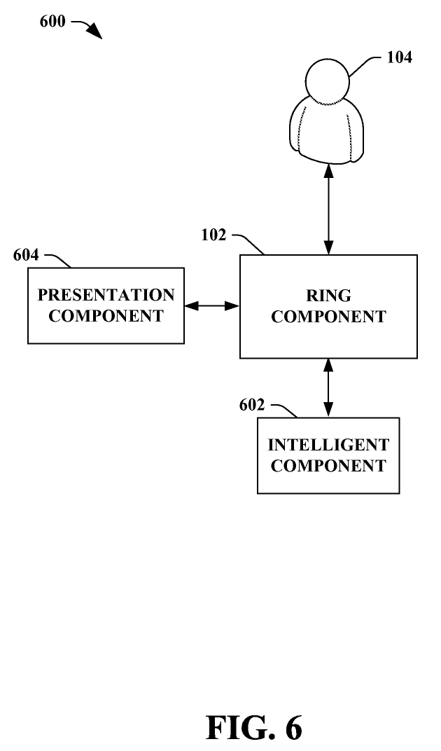

FIG. 6 illustrates a system 600 that employs intelligence to facilitate inferring and/or predicting a user's intended interaction with a device with a ring component. The system 600 can include the ring component 102 and the user 104. It is to be appreciated that the ring component 102 and the user 104 can be substantially similar to respective components, and users described in previous figures. The system 600 further includes an intelligent component 602. The intelligent component 602 can be utilized by the ring component 102 to facilitate communicating with a device (not shown) based upon the real-time detection of a motion, a gesture, an inductance, a resistance, and the like from the ring component 102. For example, the intelligent component 602 can infer user preferences, user settings, configurations for the ring component 102, linkage between data collection and functionality or feature implementation on the device 106, connectivity settings, inputs, outputs, friends or contacts, sensor settings, motions, gestures, resistance levels, conductance levels, etc.

The intelligent component 602 can employ value of information (VOI) computation in order to identify real-time collected data. For instance, by utilizing VOI computation, the most ideal and/or appropriate real-time collected data can be determined and employed to interact with the device. Moreover, it is to be understood that the intelligent component 602 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

The ring component 102 can further utilize a presentation component 604 that provides various types of user interfaces to facilitate interaction between a user and any component coupled to the ring component 102. As depicted, the presentation component 604 is a separate entity that can be utilized with the ring component 102. However, it is to be appreciated that the presentation component 604 and/or similar view components can be incorporated into the ring component 102 and/or a stand-alone unit. The presentation component 604 can provide one or more graphical user interfaces (GUIs), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components coupled and/or incorporated into the ring component 102.

The user can also interact with the regions to select and provide information via various devices such as a mouse, a roller ball, a touchpad, a keypad, a keyboard, a touch screen, a pen and/or voice activation, a body motion detection, for example. Typically, a mechanism such as a push button or the enter key on the keyboard can be employed subsequent entering the information in order to initiate the search. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can then provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, EGA, VGA, SVGA, etc.) with limited graphic support, and/or low bandwidth communication channels.

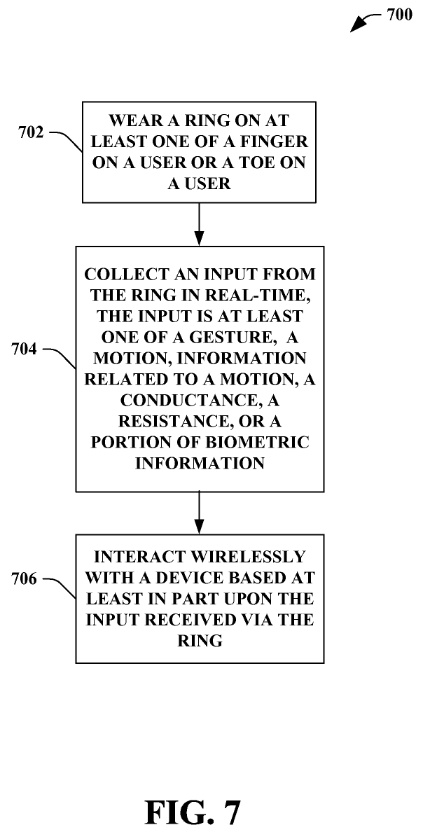

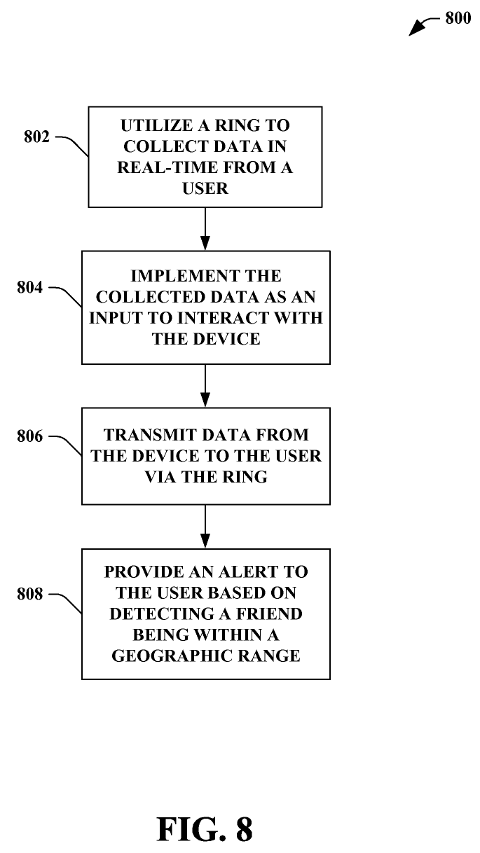

FIGS. 7-8 illustrate methodologies and/or flow diagrams in accordance with the claimed subject matter. For simplicity of explanation, the methodologies are depicted and described as a series of acts. It is to be understood and appreciated that the subject innovation is not limited by the acts illustrated and/or by the order of acts. For example acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 7 illustrates a method 700 that facilitates communicating with a device utilizing a ring component worn by a user on a digit. At reference numeral 702, a ring can be worn on at least one of a finger on a user or a toe on a user. Specifically, the ring can be worn by the user on a digit or finger on at least one hand or on a toe on at least one foot. The ring can be further attached to or worn on a portion of the user (e.g., a ring on a necklace, etc.), a waist of a user, a leg of a user, an arm of a user, a wrist of a user, a neck of a user, an ankle of a user, and/or any other body part of portion of the user to which a ring can worn.

At reference numeral 704, an input from the ring can be collected in real-time, wherein the input is at least one of a gesture, a motion, information related to a motion, a conductance, a resistance, or a portion of biometric information. In particular, the ring can aggregate data from a user utilizing various sensors that can sense information such as, but not limited to, position, speed, direction, motion, orientation in comparison to another ring, temperature, moisture, biometric data, pressure, speed, light, sound, acceleration, weight, user emotions, etc.

At reference numeral 706, a device can be interacted with wirelessly based at least in part upon the input received via the ring. The wireless interaction can be with the device or a portion of data displayed by a device, wherein the device can be, but is not limited to being, a computing device, a smartphone, a mobile communication device, a machine, a computer, a laptop, a portable digital assistant (PDA), a data browsing device, a display (e.g., a television, a plasma display, an LCD, a flat screen, a computer display, a CRT, a monitor, etc.), a gaming device, a portable device, a portable gaming device, a two-way communication device, a hand-held, a global positioning system (GPS) device, a media player, a media device (e.g., audio player, video player, etc.), a cellular device, a wireless device, and the like.

FIG. 8 illustrates a method 800 for employing one or more ring components to communicate or interface with a device displaying a portion of data. At reference numeral 802, a ring can be utilized to collect data in real-time from a user. At reference numeral 804, the collected data can be implemented as an input to interact with a device or a portion of displayed data on the device. For example, the input from the ring can be a squeeze, a pressure, a turning, a spinning, a speed in any suitable direction on a 3-dimensional axis, a linear movement, a movement or motion, an acceleration in a direction, a drawing of a character, a simulated portion of writing, a simulation of typing on a keyboard, a shaking motion, a stretching of fingers, a grabbing motion, a sign associated with sign language, a sign (e.g., an “OK” sign, a thumbs up, a thumbs down, a peace sign, stop signal, waive, etc.), a combination of displaying certain digits and not other digits, a gesture involving two hands (e.g., clapping, rubbing of hands together, etc.), a gesture involving a first finger on a first hand a second finger on a second hand (e.g., itsy-bitsy spider, a cross made with two index fingers, simulated moose antlers on a head using each hand as a set of antlers, etc.), etc.

At reference numeral 806, data from the device can be transmitted via the ring to the user. In other words, the ring can be utilized as an output component for the device. The output can be, but is not limited to being, a vibration, a color change, a temperature change (e.g., an increase in ring temperature, a decrease in temperature, etc.), a sound, a portion of visual data, a scrolling marquee (e.g., text, graphics, etc.), a light, an attraction to a disparate ring, a repelling force to a disparate ring, and/or any other suitable output that can be incorporated into a ring worn on a digit on the user. At reference numeral 808, an alert can be provided to the user based upon the detection of a friend being within a geographic range of the user.

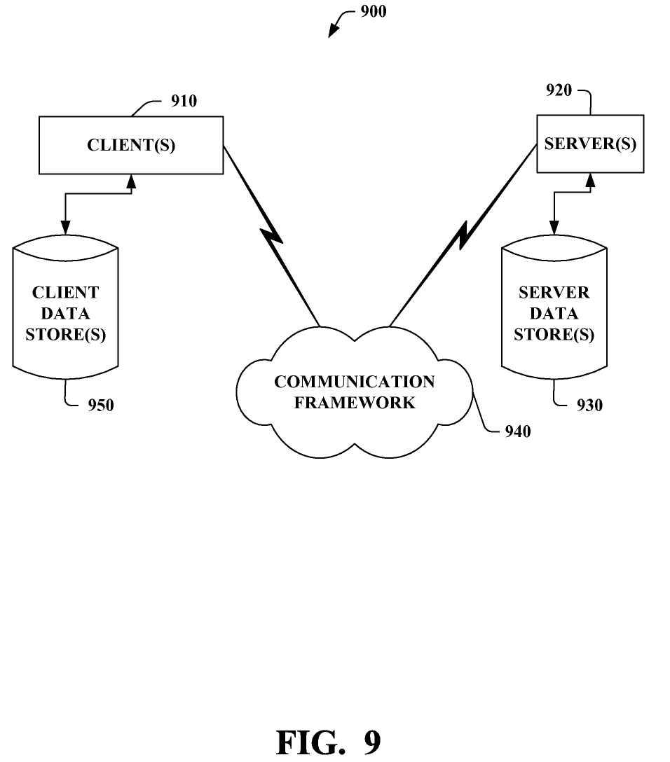

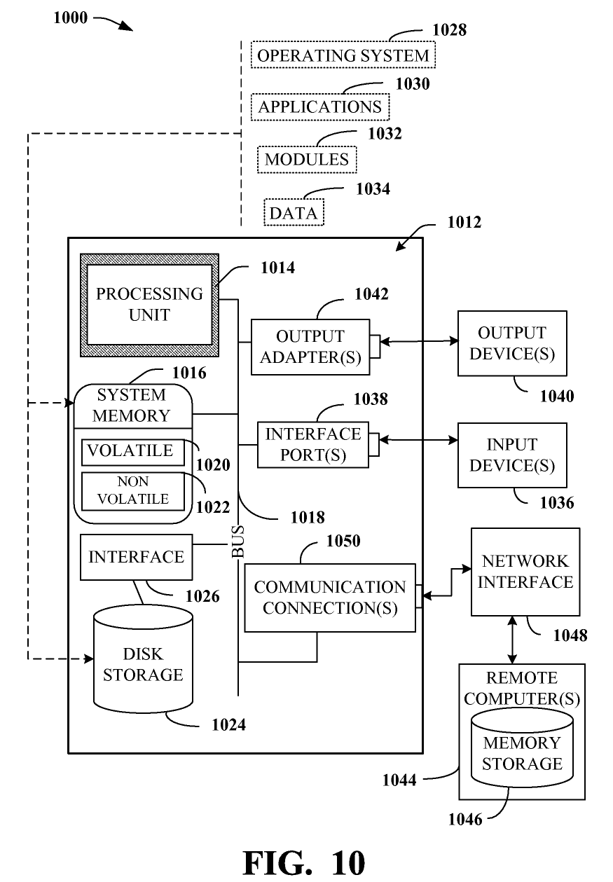

In order to provide additional context for implementing various aspects of the claimed subject matter, FIGS. 9-10 and the following discussion is intended to provide a brief, general description of a suitable computing environment in which the various aspects of the subject innovation may be implemented. For example, a ring component that enables device and data interaction while being worn on a digit on a hand or a toe on a foot, as described in the previous figures, can be implemented in such suitable computing environment. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 9 is a schematic block diagram of a sample-computing environment 900 with which the claimed subject matter can interact. The system 900 includes one or more client(s) 910. The client(s) 910 can be hardware and/or software (e.g., threads, processes, computing devices). The system 900 also includes one or more server(s) 920. The server(s) 920 can be hardware and/or software (e.g., threads, processes, computing devices). The servers 920 can house threads to perform transformations by employing the subject innovation, for example.

One possible communication between a client 910 and a server 920 can be in the form of a data packet adapted to be transmitted between two or more computer processes. The system 900 includes a communication framework 940 that can be employed to facilitate communications between the client(s) 910 and the server(s) 920. The client(s) 910 are operably connected to one or more client data store(s) 950 that can be employed to store information local to the client(s) 910. Similarly, the server(s) 920 are operably connected to one or more server data store(s) 930 that can be employed to store information local to the servers 920.

With reference to FIG. 10, an exemplary environment 1000 for implementing various aspects of the claimed subject matter includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable programmable ROM (EEPROM), or flash memory. Volatile memory 1020 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1012 also includes removable/non-removable, volatile/non-volatile computer storage media. FIG. 10 illustrates, for example a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in the suitable operating environment 1000. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the claimed subject matter can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012, and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

There are multiple ways of implementing the present innovation, e.g., an appropriate API, tool kit, driver code, operating system, control, standalone or downloadable software object, etc. which enables applications and services to use the advertising techniques of the invention. The claimed subject matter contemplates the use from the standpoint of an API (or other software object), as well as from a software or hardware object that operates according to the advertising techniques in accordance with the invention. Thus, various implementations of the innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A computer-implemented system that facilitates interacting with a device, comprising:
a computing device that displays a portion of data; and
a ring component that interacts with the portion of data to control the device by detecting at least one of a movement, a gesture, an inductance, or a resistance related to a user wearing the ring component on at least one of a digit on at least one hand or a toe on at least one foot.

2. The system of claim 1, the ring component incorporates a sensor, the sensor detects at least one of acceleration, a geographic position, a location in comparison to the user, a biometric measurement, a temperature, a pressure, a motion, a speed, a portion of light, a sound, a portion of moisture, a weight, or a conductance.

3. The system of claim 1, the ring component collects biometric data to infer an emotion related to the user, the biometric data is at least one of a heart rate, a blood pressure, a breathing pattern, a retinal activity, a skin tone, or a portion of neural activity.

4. The system of claim 3, the computing device changes at least one of a functionality of the computing device, a mode of the computing device, a feature of the computing device, or the portion of displayed data on the computing device based in part upon the inferred emotion.

5. The system of claim 1, the ring component is worn on at least one of a portion of the user, a waist of a user, a leg of a user, an arm of a user, a wrist of a user, a neck of a user, or an ankle of a user.

6. The system of claim 1, the computing device is at least one of a smartphone, a mobile communication device, a machine, a computer, a laptop, a portable digital assistant (PDA), a data browsing device, a display, a television, a plasma display, an LCD, a flat screen, a computer display, a CRT, a monitor, a gaming device, a portable device, a portable gaming device, a two-way communication device, a hand-held, a global positioning system (GPS) device, a media player, a media device, an audio player, a video player, a cellular device, or a wireless device.

7. The system of claim 1, the ring component is a sensor to provide at least one of radio frequency identification (RFID) functionality, a proximity detection, a Wi-Fi capability, or a context awareness.

8. The system of claim 1, the ring component detects at least one of an orientation, a distance, a location, a contact, a proximity, or a motion in connection with a disparate ring component, the detection is utilized as an input for the computing device.

9. The system of claim 8, the computing device is controlled by a type of contact between two or more ring components, the type of contact includes at least one of location data between the two or more ring components, a force associated with the two or more ring components, a pressure detected with the contact between the two or more ring components, or a frequency of the contact between the two or more ring components.

10. The system of claim 1, the gesture is at least one of a squeeze, a pressure, a turning, a spinning, a speed in a direction on a 3-dimensional axis, a drawing of a character, a simulated portion of writing, a simulation of typing on a keyboard, a shaking motion, a stretching of a finger, a stretching of a toe, a grabbing motion, or a sign associated with sign language.

11. The system of claim 1, the gesture is at least one of a sign, an “OK” sign, a thumbs up, a thumbs down, a peace sign, a stop signal, a waive, a combination of displaying at least one digit and not a disparate digit, a gesture involving two hands, or a gesture involving a first finger on a first hand a second finger on a second hand.

12. The system of claim 1, the ring component communicates an output from the computing device, the ring communicates the output with at least one of a vibration, a color change, a temperature change, an increase in ring temperature, a decrease in temperature, a sound, a portion of visual data, a scrolling marquee, a light, an attraction to a disparate ring, or a repelling force to a disparate ring.

13. The system of claim 1, the ring component employs a portion of physical feedback in connection with interaction with at least one of the computing device or the portion of displayed data on the computing device.

14. The system of claim 1, further comprising a proximity alert component that analyzes geographic positioning data associated with one or more contacts related to the user, the ring component transmits an alert to the user based on one or more contacts being within a defined geographic distance in comparison to the user.

15. The system of claim 14, the one or more contacts is populated from at least one of an address book related to the user, a user's contact list, a data file, a social network associated with the user, or a network.

16. The system of claim 1, the ring component interacts with data associated with at least one of the following:
a display engine that provides at least one of a seamless pan or a seamless zoom the portion of displayed data, the portion of displayed data includes at least two substantially parallel planes of view in which a first plane and a second plane are alternatively displayable based upon a level of zoom and which are related by a pyramidal volume;
a browsing engine that implements at least one of a seamless pan or a seamless zoom for the displayed data in connection with at least one of the Internet, a network, a server, a website, or a web page; or
a content aggregator that collects a plurality of two dimensional (2D) content to create a three dimensional (3D) virtual environment.

17. A computer-implemented method that facilitates interacting with a portion of data in real-time, comprising:
wearing a ring on at least one of a finger on a user or a toe on a user;
collecting an input from the ring in real-time, the input is at least one of a motion, a portion of information related to a motion, a conductance, an inductance, a resistance, or a portion of biometric information; and
interacting wirelessly with a device based at least in part upon the input receive via the ring.

18. The method of claim 17, further comprising:
transmitting a portion of data from the device to the user via the ring; and
providing an alert to the user based on detecting a friend is within a geographic range.

19. The method of claim 18, the portion of data is transmitted to the user by at least one of a vibration, a color change, a temperature change, an increase in ring temperature, a decrease in temperature, a sound, a portion of visual data, a scrolling marquee, a light, an attraction to a disparate ring, or a repelling force to a disparate ring.

20. A computer-implemented system that facilitates communicating with a device comprising:
means for displaying a portion of data;
means for collecting data in real-time with a ring component that is worn on at least one of a finger on a user or a toe on a user, the ring component provides real-time detection of at least one of a movement, a gesture, an inductance, a conductance, a portion of biometric information, or a resistance utilizing a ring component;
means for utilizing the collected data to wirelessly interact with the portion of displayed data; and
means for transmitting an output to the user via the ring component, the output is related to the portion of displayed data.
